(19) United States
(12) Patent Application Publication
(10) Pub. No.: US 2017/0150410 A1
(43) Pub. Date: May 25, 2017

(54) Method and Device for Cell Reselection for Terminal

(71) Applicant: ZTE CORPORATION, Shenzhen City, Guangdong Province (CN)

(72) Inventors: Xiangling YANG, Shenzhen (CN); Dingyuan TU, Shenzhen (CN)

(21) Appl. No.: 15/313,092

(22) PCT Filed: Jul. 17, 2014
(86) PCT No.: PCT/CN2014/082427

§ 371 Date: Nov. 21, 2016

(30) Foreign Application Priority Data
May 22, 2014 (CN) 201410217022.3

(51) Int. Cl. H04W 36/04; H04W 36/00; H04W 36/30

(52) U.S. Cl. CPC H04W 36/04; H04W 36/30; H04W 36/0088

(57) ABSTRACT

The present document discloses a method and apparatus for cell reselection for a terminal, related to the technical field of wireless communications, and the method includes the following steps: when performing cell reselection according to signal quality or service performance of a serving cell, a terminal acquiring a first neighboring cell list from a system side; selecting a neighboring cell satisfying a cell reselection condition from the first neighboring cell list; if none of neighboring cells in the first neighboring cell list satisfies the cell reselection condition, then the terminal performing active search to obtain other neighboring cell satisfying the cell reselection condition, and residing in the other neighboring cell. The present document can make a terminal actively search for an optimum cell existing around and reside under the scenario of weak signals, and is beneficial to improve wireless performance and user experience.

### TECHNICAL FIELD

The present document relates to the technical field of wireless communications, and is an improvement to the existing cell reselection mechanism at a terminal device.

### BACKGROUND OF THE RELATED ART

The cell reselection refers to a process that the UE, in an idle mode, selects one best cell to provide a serving signal through monitoring signal qualities of a neighboring cell and a current cell. Taking the LTE as an example, the existing cell reselection mechanism is as follows:

1. The LTE Cell Selection Criterion:

In the cell reselection process, the UE needs to measure a cell to be selected, in order to perform a channel quality assessment to judge whether the cell satisfies the residence criterion. The cell selection criterion is referred to as S criterion. When channel quality of a certain cell satisfies the S criterion, the cell may be selected as the residence cell. The specific contents of the S criterion are as follows. The meaning of various parameters of the S criterion is as shown in table 1:

Srxlev>0 and Squal>0

Srxlev=Qrxlevmeas−(Qrxlevmin+Qrxlevminoffset)−Pcompensation

Squal=Qqualmeas−(Qqualmin+Qqualminoffset)

When the UE performs the cell selection, the RSRP value of the cell is acquired through measuring the Qrxlevmeas, other parameters of the S criterion formula are acquired by system information of the cell and its own capability level, and the Srxlev is acquired by calculation and then is compared with 0. If the Srxlev>0, then the UE considers that the cell satisfies the channel quality requirement of the cell selection, and may select the cell as the residence cell. If the system information of that cell indicates that the cell is allowed to be resided, then the UE will select to reside in the cell, and enter the idle state.

2. The LTE Cell Reselection

The cell reselection occasion: 1) when UE is powered on and resides in a suitable cell, then the cell reselection is started; 2) the UE under the RRC_IDLE state is mobile.

The rule of cell reselection: 1) the UE enables the cell reselection process through measuring the attributes of the serving cell and the neighboring cell; 2) the system information of the serving cell indicates the information that the UE searches for and measures the neighboring cell; 3) the cell reselection criterion is related to the measurements of the serving cell and the neighboring cell; 4) the cell reselection parameters may be applied to all UEs in the cell, but specific configuration parameters may be configured for a certain UE or UE group.

The cell reselection process: 1) the UE evaluates all RAT frequencies based on priority; 2) the UE compares all cells on relevant frequencies by using the ranking criterion and based on the quality of the wireless link; 3) once the target cell is reselected, the UE verifies the accessibility of that cell; 4) if there is no access limitation, the target cell is reselected.

The priority for the cell reselection is considered as follows: the acquisition paths for the absolute priority of different frequencies of the eUTRAN or the frequency of the IRAT include: 1) system information; and 2) an RRCConnectionRelease message.

When the UE is in the idle state, after the cell is selected, the UE needs to continuously perform the cell reselection to reside in a cell with a higher priority or better channel quality. The network can achieve the purpose of controlling the UE residence by setting the priorities of different frequency points; and at the same time, the UE will select the cell with the best channel quality at a certain frequency point in order to provide a better service.

The cell reselection may be divided into the intra-frequency cell reselection and inter-frequency cell reselection. The intra-frequency cell reselection can solve the problem of the wireless coverage; and the inter-cell reselection may not only solve the problem of the wireless coverage, but also may achieve the load balancing by setting the priorities of different frequency points. Herein, the processes of the intra-frequency cell reselection and inter-frequency cell reselection are shown in FIG. 3 and FIG. 4 respectively.

(1) The Intra-Frequency Cell Reselection

The measurement criterion: in order to maximize the battery life of the UE, the UE does not need to perform the frequent neighboring cell monitoring (measurement) at all times, unless the quality of the serving cell is dropped below the specified threshold value. S_{intrasearch} is a threshold parameter used for judging whether to perform the intra-frequency cell reselection when the intra-frequency cell reselection is performed. When the S value of the LTE serving cell is less than or equal to the S_{intrasearch}, it is necessary to perform the intra-frequency cell reselection measurement; in addition, if the S_{intrasearch} parameter is not broadcasted in the system message, the intra-frequency cell reselection measurement is also required to be performed. In addition, the UE may select not to measure.

The cell ranking: an R criterion ranking is performed on the candidate cells according to the channel quality to select the optimal cell, herein, the meaning of the reselection parameters of the intra-frequency cells sees in table 2.

R criterion: for the serving cell, Rs=Qmeas,s+QHyst; for the neighboring cell, Rn=Qmeas, n−Qoffset.

The cell reselection criterion the reselection object of the intra-frequency cells may be a cell in the neighboring cell list, and also may a cell detected during the reselection process. The queuing and selection process are required to satisfy the following restriction conditions: 1) the duration T_{duration} where the channel quality of the new target cell is better than the quality of the current serving cell in the ranking, is not less than the T_{reselectionRAT}; 2) if the UE is in a uncommon mobile state (medium or high speed), then it is required to consider zooming the parameter T_{reselectionRAT} and Qhyst; 3) the time that the UE resides in the original cell is more than 1 s.

(2) Inter-Frequency Cell Reselection:

In the inter-frequency cell reselection process, the eNodeB may achieve the load balancing of cells with different frequency points by setting different priority parameters for various frequency points. The inter-frequency cell reselection mainly includes the following steps.

The measurement criterion: for the frequency, whose priority is higher than the priority of the current frequency, which is indicated by the system information, the UE always performs the measurement on these high priority frequencies; for the frequency, whose priority is equal to or lower than the priority of the current frequency, which is indicated by the system information, the measurement criterion of the UE is as follows: 1) if the S value of the serving cell is greater than the threshold value S nonintrasearch, then the measurement is not performed; 2) if the S value of the service cell is less than or equal to the threshold value S nonintrasearch, then the measurement is performed.

The priority processing: the UE may obtain the priority information (public priority) of the frequency point through the broadcast message, or obtain the priority information (public priority) of the frequency point through the RRC connection release message. If a dedicated priority is provided, then the UE will ignore all public priorities. If the system information does not provide the priority information of the cell where the UE currently resides, the UE will set the priority of the frequency point which is located at the cell as the lowest. The UE only performs the cell reselection among the frequency points appeared in the system information and provided with the priority according to the priority strategy.

The cell reselection criterion: the cell reselection of the frequency points with high priority is performed after the following conditions are satisfied. 1) For the cell with high priority frequency, Squal>ThreshX, HighQ and the duration is more than T_{reselectionRAT}; 2) for the cell with high priority frequency, Srxlev>ThreshX, HighP and the duration is more than T_{reselectionRAT}; and the time that the UE resides in the original cell is more than 1 s.

If multiple neighboring cells at the highest priority satisfy the criterion, then the optimal cell on the highest priority frequency is selected. For the same priority frequency points/the same frequencies, the R criterion of the intra-frequency cell reselection is adopted.

The cell reselection of the frequencies with low priority is performed after the following conditions are satisfied. 1) No cell with high priority frequency satisfies the reselection requirement; 2) no cell with the same priority frequency satisfies the reselection requirement; 3) for the serving cell, Squal<ThreshServing, LowQ; 4) for the target cell, Squal>ThreshX, LowQ and the duration is more than T_{reselectionRAT}; 5) for the serving cell, Srxlev<ThreshServing, LowP; 6) for the target cell, Srxlev>ThreshX, LowP and the duration is more than T_{reselectionRAT}; 7) the time that the UE resides in the original cell is more than 1 s.

The reselection object of the inter-frequency cells may be a cell in the neighboring cell list, and also may a cell detected during the cell reselection process. If the detection result for the UE speed shows that the cell is in the uncommon (medium or high speed) mobile state, the zoomed parameter T_{reselectionRAT} should be used in the reselection process.

At present, although up to 45 neighboring cells may be defined in the system database, but those transferred to the mobile phone by the system through the NLUM message via the air interface are only 20, and the 20 neighboring cells are selected from a database list of multiple neighboring cells of the current serving cell by the system according to a certain algorithm. The system usually performs the selection depending on the signal strengths and qualities of those cells in the selection process, and as per the preset algorithm according to static definition of the database. So if a certain neighboring cell B is not statically defined in the neighboring cell list of the system, or is not selected by the selection algorithm due to the too low priority although it is declared, then the certain neighboring cell B cannot be broadcasted to the mobile phone through the NLUM via the air interface, and the neighboring cell register of the mobile phone will not have the information of that cell. So there may be a cell with good signal strength and quality which does not exist in the neighboring cell list. That is, neighboring cell leakage is occurred.

Secondly, the terminal, in the idle state, will perform periodically measurement on the neighboring cells according to the information of the neighboring cells in the system message at the network side. After the signal quality of the cell satisfies the cell reselection conditions specified by the network side, the cell will be reselected from the current serving cell to a better new cell. In this way, the terminal will only measure the cells existed in the neighboring cell list, and will reside in the original serving cell when finding that the cell reselection conditions specified by the network side are not satisfied, which causes the problems that the terminal stays in a serving cell with a weak signal for a long time, the paging message cannot be normally received, and the data service performance is reduced, and so on.

### SUMMARY

The purpose of the present document is to provide a method and apparatus for cell reselection for a terminal, which can better solve the problems that the terminal stays in the serving cell with the weak signal for a long time due to leakage or unreasonable setting of the neighboring cell in the weak signal area, thus the terminal cannot normally receive the paging messages, and the data service performance declines, and so on.

A method for cell reselection for a terminal is provided according to one aspect of the present document. The method includes: when performing cell reselection according to signal quality or service performance of a serving cell, a terminal acquiring a first neighboring cell list from a system side; selecting a neighboring cell satisfying a cell reselection condition from the first neighboring cell list; if none of neighboring cells in the first neighboring cell list satisfies the cell reselection condition, then the terminal performing active search to obtain other neighboring cell satisfying the cell reselection condition, and residing in the other neighboring cell satisfying the cell reselection condition.

Alternatively, the terminal performs the cell reselection when the service performance of the terminal declines and a duration that the service performance declines is greater than a preset declination time.

Alternatively, the step of the terminal performing active search to obtain other neighboring cell satisfying the cell reselection condition, and residing in the cell includes: through the active search, the terminal acquiring the other neighboring cells, which are supported by the terminal, other than the neighboring cells in the first neighboring cell list, to generate a second neighboring cell list; determining priorities of various neighboring cells by means of respectively performing cell measurements on the various neighboring cells in the second neighboring cell list; selecting a neighboring cell with a highest priority, and judging whether the neighboring cell with the highest priority satisfies the cell reselection condition; and if the neighboring cell with the highest priority satisfies the cell reselection condition, then residing in the neighboring cell with the highest priority.

Alternatively, the step of generating a second neighboring cell list includes: the terminal actively searching for frequency points and network modes supported by the terminal to obtain all neighboring cells of the service cell; and deleting the neighboring cells in the first neighboring cell list from all obtained neighboring cells to obtain the second neighboring cell list generated by remaining neighboring cells.

Alternatively, the step of determining priorities of various neighboring cells by means of respectively performing cell measurements on the various neighboring cells in the second neighboring cell list includes: obtaining signal strengths and qualities of various neighboring cells by means of respectively performing cell measurements on the various neighboring cells in the second neighboring cell list; and by using the signal strengths and qualities of the various neighboring cells, obtaining the priorities of the various neighboring cells respectively, and ranking the priorities in a sequence from high to low.

Alternatively, the step of judging whether the neighboring cell with the highest priority satisfies the cell reselection condition includes: judging whether the neighboring cell with the highest priority satisfies the cell reselection condition when the neighboring cell with the highest priority satisfies an S criterion and a duration where the priority of the neighboring cell with the highest priority is higher than a priority of the serving cell, is greater than a preset reselection time.

Alternatively, after the step of residing in the other neighboring cell satisfying the cell reselection condition, the method further includes: the terminal monitoring the signal quality of an original serving cell; and the terminal residing in the original serving cell again if a duration where the signal quality of the original serving cell is better than that of a current resident cell, is greater than the preset reselection time.

An apparatus of cell reselection for a terminal is provided according to another aspect of the present document. The apparatus includes: an acquiring module, configured to, when a terminal performs cell reselection according to signal quality or service performance of a serving cell, acquire a first neighboring cell list from a system side; a selection module, configured to select a neighboring cell satisfying a cell reselection condition from the first neighboring cell list; and a reselection module, configured to, if none of neighboring cells in the first neighboring cell list satisfies the cell reselection condition, then perform active search by the terminal to obtain other neighboring cell satisfying the cell reselection condition, and reside in the other neighboring cell satisfying the cell reselection condition.

Alternatively, the terminal performs the cell reselection when the service performance of the terminal declines and a duration that the service performance declines is greater than a preset declination time.

Alternatively, the reselection module is further configured to reside in an original serving cell again if monitoring a duration where the signal quality of the original serving cell is better than that of the current resident cell, is greater than a preset reselection time.

Compared with the related art, the beneficial effects of the present document are that: the present document make a terminal actively search for an optimum cell existing around and reside under the scenario of weak signals, and is beneficial to improve wireless performance and user experience.

### BRIEF DESCRIPTION OF DRAWINGS

FIG. 1 is a table of meaning of LTE cell selection parameters provided by the related art.

FIG. 2 is a table of meaning of intra-frequency cell reselection parameters provided by the related art.

FIG. 3 is a flow chart of intra-frequency cell reselection provided by the related art.

FIG. 4 is a flow chart of inter-frequency cell reselection provided by the related art.

FIG. 5 is a principle block diagram of a method for cell reselection for a terminal provided by the present document.

FIG. 6 is a block diagram of an apparatus for cell reselection for a terminal provided by the present document.

FIG. 7 is a flow chart of intra-frequency cell reselection of a terminal provided by an embodiment of the present document.

FIG. 8 is a flow chart of inter-frequency cell reselection of a terminal provided by an embodiment of the present document.

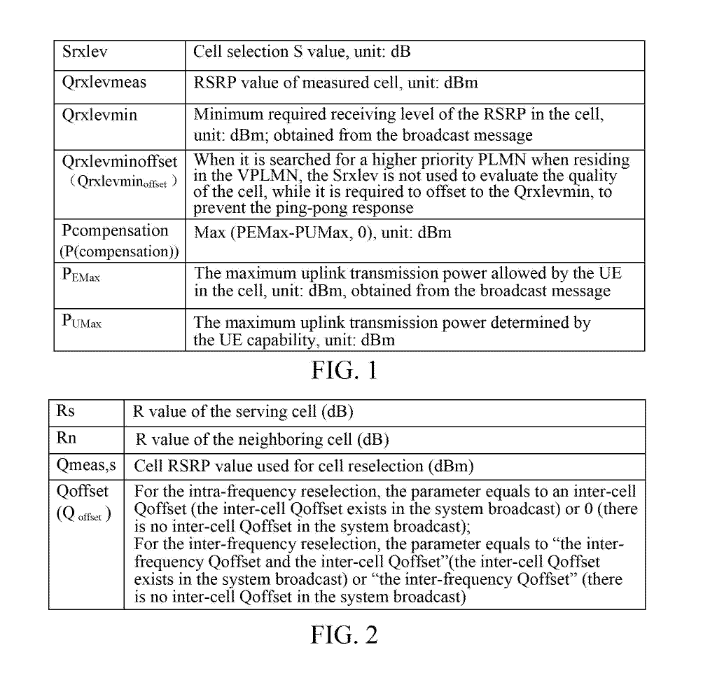

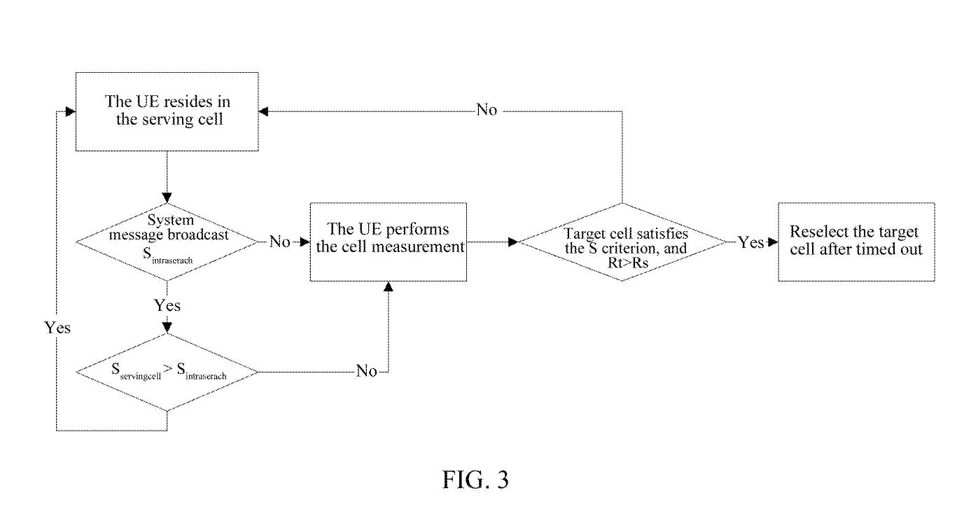

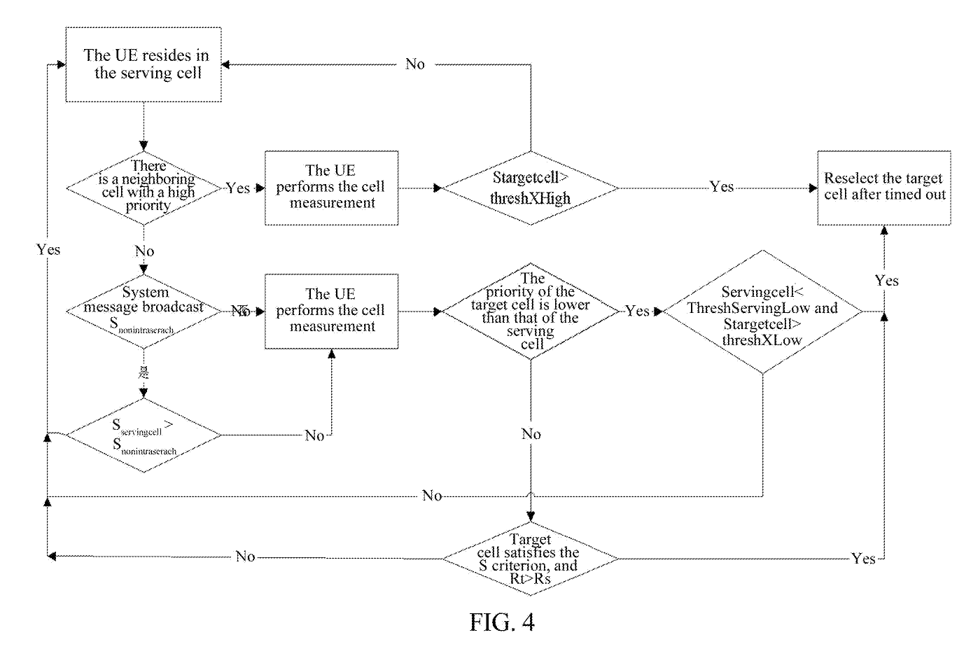

### SPECIFIC EMBODIMENTS

The preferred embodiments of the present document are described in detail with reference to the accompanying drawings hereinafter. It should be understood that, the preferred embodiments illustrated hereinafter are used only to describe and explain the present document, rather than limiting the present document.

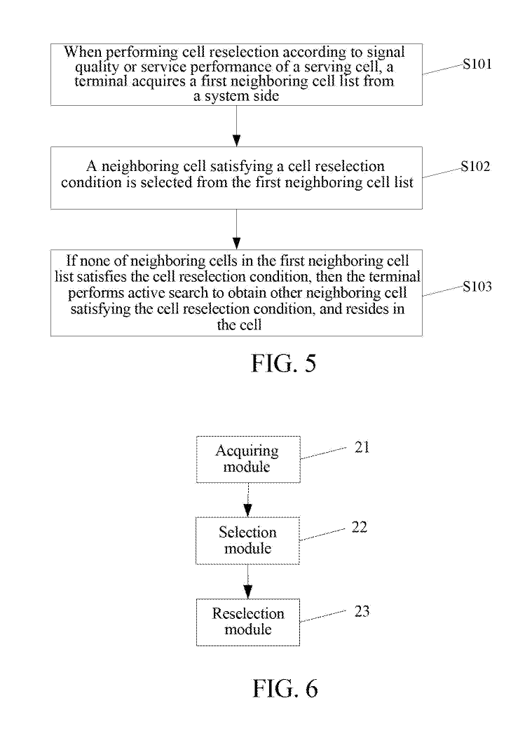

FIG. 5 is a principle block diagram of a method for cell reselection for a terminal provided by the present document. As shown in FIG. 5, the steps including the following.

In step S101, when performing cell reselection according to signal quality or service performance of a serving cell, a terminal acquires a first neighboring cell list from a system side.

Taking the intra-frequency cell reselection as an example, when the signal quality of the current serving cell Ss is not greater than the intra-frequency cell reselection threshold Sintrasearch, the terminal performs the neighboring cell measurement to determine whether to perform the reselection. Or, the terminal performs the cell reselection when the service performance of the terminal declines and a duration that the service performance declines is greater than a preset declination time.

Herein, the neighboring cells in the above first neighboring cell list are part of all neighboring cells of the current serving cell of the terminal, and are obtained from the system message sent from the system side.

In step S102, a neighboring cell satisfying a cell reselection condition is selected from the first neighboring cell list.

Taking the intra-frequency cell reselection as an example, the terminal performs the cell measurements on various neighboring cells in the first neighboring cell list, calculates rank values of various neighboring cell, and performs the arrangement in accordance with the rank value from a large to small order. If signal quality St of a certain neighboring cell satisfies the S criterion, and the duration where its priority is greater than the priority of the current serving cell, is greater than the preset reselection time, then it is determined that the neighboring cell is the neighboring cell which satisfies the cell reselection condition; otherwise, it is determined that the neighboring cell is the neighboring cell which does not satisfy the cell reselection condition.

In step S103, if none of the neighboring cells in the first neighboring cell list satisfies the cell reselection condition, then the terminal performs active search to obtain other neighboring cell satisfying the cell reselection condition, and resides in the other neighboring cell satisfying the cell reselection condition.

The terminal actively searches for its supported frequency points and network modes to obtain all neighboring cells of the serving cell. The terminal deletes the neighboring cells in the first neighboring cell list from all obtained neighboring cells to obtain the second neighboring cell list generated by remaining neighboring cells. The signal strengths and qualities of various neighboring cells are obtained by means of performing cell measurements on various neighboring cells in the second neighboring cell list. By using the signal strengths and qualities of various neighboring cells, priorities of various neighboring cells are obtained respectively. The arrangement is performed according to the priority order from high to low. The neighboring cell with the highest priority is selected, and it is judged whether the neighboring cell with the highest priority satisfies the cell reselection condition; if the neighboring cell with the highest priority satisfies the S criterion, and the duration where its priority is higher than the priority of the serving cell, is greater than the preset reselection time Treselection, then it is determined whether the neighboring cell with the highest priority satisfies the cell reselection condition, and the terminal resides in the neighboring cell with the highest priority.

After the step of residing in other neighboring cell which satisfies the cell reselection condition, the terminal monitors signal quality of an original serving cell, and the terminal resides in the original serving cell again if a duration where the signal quality of the original serving cell is better than that of a current resident cell, is greater than the preset reselection time.

FIG. 6 is a block diagram of an apparatus for cell reselection for a terminal provided by the present document. As shown in FIG. 6, the apparatus includes an acquiring module 21 and a selection module 22 and a reselection module 23, which realize various steps as shown in FIG. 5, herein:

the acquiring module 21 acquires a first neighboring cell list from a system side when a terminal performs cell reselection according to signal quality or service performance of a serving cell; the selection module 21 selects a neighboring cell satisfying a cell reselection condition from the first neighboring cell list; and if none of the neighboring cells in the first neighboring cell list satisfies the cell reselection condition, then the reselection module 23 performs active search, obtains other neighboring cell satisfying the cell reselection condition, and resides in other neighboring cell satisfying the cell reselection condition. The reselection module 23 is further configured to reside in an original serving cell again if monitoring a duration where signal quality of the original serving cell is better than that of the current resident cell, is greater than a preset reselection time.

The present document not only follows the cell reselection criterion specified by the network side, but also increases a user experience judgment condition given by the terminal side used for dynamically improving the threshold value to perform the measurement of the neighboring cell. When it is found that the user experience of the terminal is worse than the threshold value and none of the cells in the neighboring list satisfies the reselection condition, the terminal actively searches for various frequency points except the neighboring cell under the supported frequency band, scans the frequency points and network modes which are required to be searched for in sequence according to the PLMN, LAC, RAT, and the cells which used to reside in, and so on, assigns a weighted value and performs the ranking according to the signal strength and quality, and then selects the appropriate target cell for registration. Finally, a periodic timer is given, the terminal actively measures whether the previous serving cell has been out of the weak signal area after the periodic timer is timed out; if yes, then the terminal returns to the original serving cell.

The innovation of the present document includes the following parts:

1. The terminal side gives the judgment condition of the worse user experience: the duration Tduration2 that the voice and data service performance decline is greater than a specified value (which may be set by the user, and recommended as 20˜60 s), and it is believed to be in a weak signal service area.

2. When the terminal is in the weak signal service area and none cell in the neighboring cell list satisfies the reselection condition, the terminal actively searches for various frequency points except the neighboring cells, under the supported frequency band.

3. The above cells, frequency points and network modes are assigned with a weighted value and ranked to select an optimal target cell for registration.

4. After a new cell is reselected, the timer is started, and the signal quality of the original cell is measured.

5. After the duration that the signal quality of the original cell is better than that of the new cell exceeds the threshold, the terminal returns to the original serving cell.

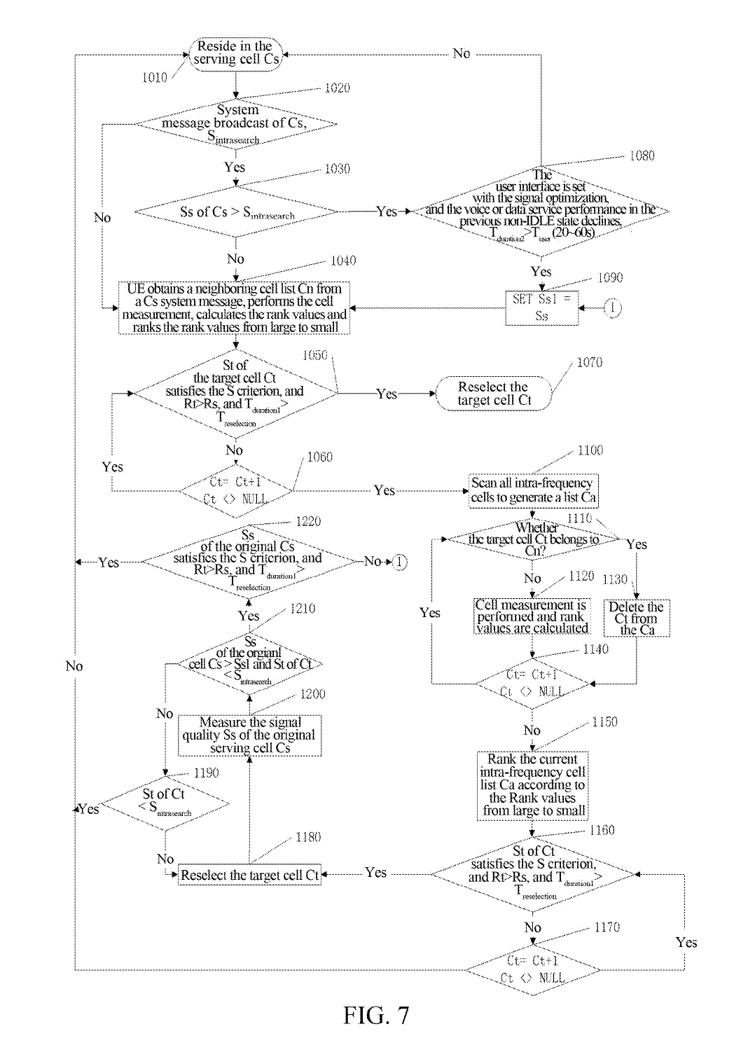

FIG. 7 is a flow chart of an intra-frequency cell reselection of a terminal provided by an embodiment of the present document. As shown in FIG. 7, the following labels [1010] to [1070] belong to the existing intra-frequency cell reselection process, while the others belong to the process added by the embodiment of the present document.

The LTE resides in the appropriate cell, and it may perform the cell reselection process after staying for appropriate time (1 second). Through the cell reselection, it may be ensured at the maximum that the UE in the idle mode resides in the appropriate cell.

In the idle mode, the cell reselection is triggered through monitoring the measurement values of the serving cell Cs and the neighboring cell Cn. The core content of the reselection triggering condition is that: there is a cell better than the serving cell, and the better cell maintains the best in a period of time. In this way, on one hand, the UE reselects a better cell as possible; and on the other hand, a certain stability is ensured to avoid the frequent reselection concussion.

The cell reselection in the LTE is divided into two kinds, the intra-frequency cell reselection and the inter-frequency cell reselection (including the cell reselection among different RATs). The parameters related to the cell reselection are from the system message SIB3, SIB4 and SIB5 of the serving cell.

The SIM contains the information of the intra-frequency and inter-frequency (including the Inter-RAT) reselection.

[1020, 1030 and 1040]

Taking the intra-frequency reselection as an example, the parameters related to the intra-frequency cell reselection are defined in the intraFreqCellReselectionInfo. Herein, Sintrasearch is a threshold parameter used for judging whether to perform the intra-frequency cell reselection when the intra-frequency cell reselection is performed.

When the S value Ss of the LTE serving cell is less than or equal to the Sintrasearch, it is necessary to perform the intra-frequency cell reselection measurement; In addition, if the Sintrasearch parameter is not broadcasted in the system message, it is also required to perform the intra-frequency cell reselection measurement. In addition, the UE may select not to measure.

[1080 and 1090]

When the S value Ss of the LTE serving cell is greater than Sintrasearch, firstly it is judged whether the user interface is set with the signal optimization; if yes and the duration Tduration2, that the voice or data service performance declines in the non-IDLE state before IDLE, is greater than a weak signal timed out optimal time, specified by the user, Tuser (recommended as 20 s˜60 s), then the current Ss value is stored in the variant Ss1. And the cell measurement is started.

If the above two conditions are not satisfied at the same time, then the current serving cell is resided in, and the measurement is not performed.

[1040, 1050, 1060 and 1070]

The UE obtains a neighboring cell list Cn from the system information broadcasted by the current serving cell Cs, and performs the cell measurement on the target cell Ct therein, calculates the rank values, and ranks the rank values from large to small.

The t-Reselection defines the time interval for the cell selection. In addition, some cell reselection parameters related to the mobility are further defined in the intraFreqCellReselectionInfo.

The SIB4 contains the cell relative information about the intra-frequency cell reselection, and a cell physical ID list and a corresponding offset value used for the intra-frequency cell reselection are defined in the intraFreqNeighborCellInfo. The offset value is used for formula calculation of an R criterion of the cell reselection ranking (which is described below) for the purpose of reducing the reselection oscillation.

A cell black list which cannot be used for the intra-frequency reselection is also defined in the SIB4.

For the intra-frequency cells or the different-frequency cells but with same priorities, the UE uses the R criterion to rank the cells. The so-called R criterion refers to as that the serving cell Rs and the target cell Rt respectively satisfy:

Rs=Qmeas,s+QHyst

Rt=Qmeas,t−Qoffset

Herein, Qmeas is a RSRP value of the measurement cell, and Qoffset defines an offset of the target cell. For the inter-frequency cells with the same priorities, the Qoffset includes two parts, an offset based on the cell and an offset based on the frequency.

If the target cell satisfies the S criterion in the Treselection time (the Treselection of same frequency and different frequency may be different), and Rt lasts more than Rs, then the UE will reselect the target cell.

[1100 to 1150]

If the neighboring cell list given in the system message broadcasted by the serving cell is searched completely, while a suitable cell still cannot be found, then it is required to scan all the intra-frequency cells to generate all neighboring cell list Ca obtained by active search of the mobile phone side.

All cells belonging to the neighboring cell list Cn (obtained from the system message) in the neighboring cell list Ca are deleted, because these cells have been scanned.

Those cells which do not belong to the Cn but belong to the Ca are measured. And the current intra-frequency cell list Ca is ranked as per the Rank values from large to small.

[1160 to 1180]

If the target cell Ct in the intra-frequency cell list Ca satisfies the S criterion in the Treselection time (the Treselection of same frequency and different frequency may be different), and Rt lasts more than Rs, then the UE will actively reselect the target cell Ct with the strongest and best signal.

On the contrary, if no cell in the cell list Ca satisfies the condition in [1160], then it indicates that all current neighboring cells do not satisfy the reselection condition, and the UE can only continue to reside in the original serving cell Cs.

[1190 to 1220]

The UE actively reselects the target cell Ct which does not belong to the neighboring cell list Cn given in the system broadcast message, which is only a non standard process of the mobile phone side; therefore, after the signal strength and quality of the original serving cell is recovered, it still should give priority to reselecting the cell Cs in the neighboring cell list Cn.

While now, if the signal qualities of both Ct and Cs are getting worse, the reselection must be performed in the Cn.

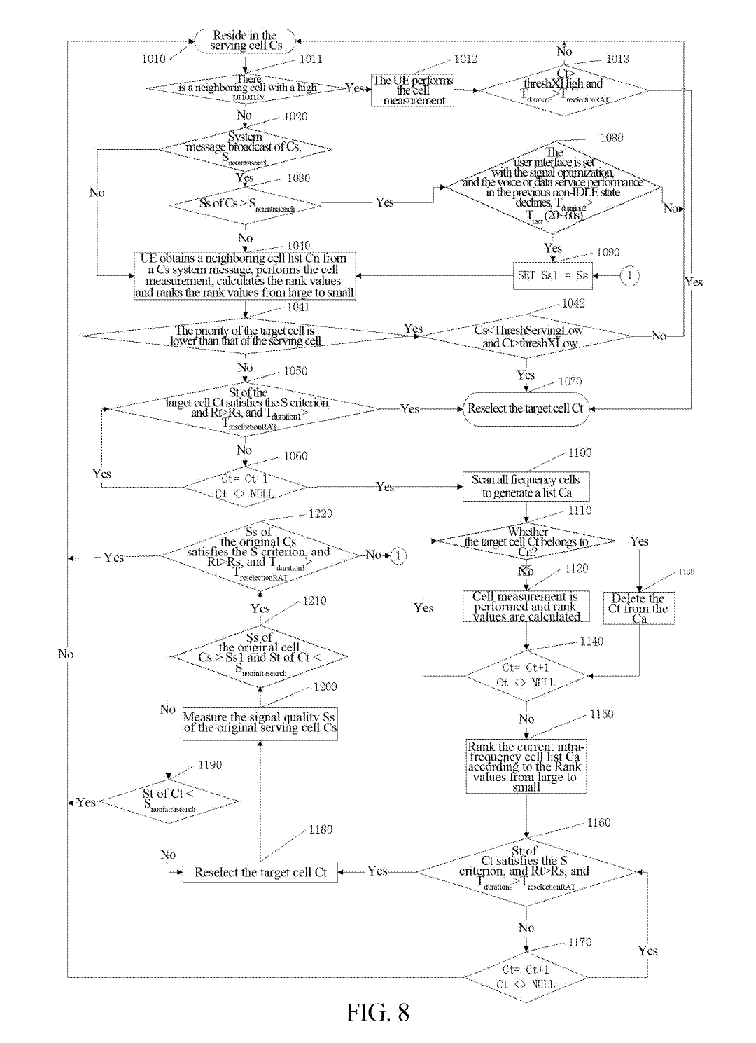

FIG. 8 is a flow chart of inter-frequency cell reselection of a terminal provided by the embodiment of the present document. As shown in FIG. 8, the following labels [1010] to [1070] belong to the process of the existing inter-frequency cell reselection, and the others belong to the process added by the present document.

In the inter-frequency cell reselection process, the eNodeB may achieve the load balancing of cells with different frequency points by setting different priority parameters for various frequency points. The LTE resides in the appropriate cell, and the LTE may perform the cell reselection process after staying for appropriate time (1 second).

[1011 and 1012]

For the frequency, whose priority is higher than the priority of the current frequency, which is indicated by the system information, the UE always performs the measurement on these high priority frequencies. [1013]

The cell reselection of the frequency points with high priority is performed after the following conditions are satisfied:

1) for the cell with high priority frequency, Squal>ThreshX, HighQ and the duration is more than T_{reselectionRAT};

2) for the cell with high priority frequency, Srxlev>ThreshX, HighP and the duration is more than T_{reselectionRAT};

and the time that the UE resides in the original cell is more than 1 s.

If multiple neighboring cells at the highest priority satisfy the criterion, then the optimal cell on the highest priority frequency is selected.

[1020, 1030 and 1040]

For the frequency, whose priority is equal to or lower than the priority of the current frequency, which is indicated by the system information, the measurement criterion of the UE is as follows:

1) if the S value of the serving cell is greater than the threshold value S_{nonintrasearch} of the inter-frequency reselection, then the measurement is not performed;

2) if the S value of the service cell is less than or equal to the threshold value S_{nonintrasearch} of the inter-frequency reselection, then the measurement is performed.

[1041 and 1042]

The cell reselection of the frequencies with low priority is performed after the following conditions are satisfied:

1) no cell with high priority frequency satisfies the reselection requirement;

2) no cell with same priority frequency satisfies the reselection requirement;

3) for the serving cell, Squal<ThreshServing,LowQ;

4) for the target cell, Squal>ThreshX,LowQ and the duration is greater than TreselectionRAT;

5) for the serving cell, Srxlev<ThreshServing,LowP;

6) for the target cell, S Srxlev>ThreshX,LowP and the duration is greater than TreselectionRAT;

7) the time that the UE resides in the original cell is more than 1 s.

[1080, 1090]

When the S value Ss of the LTE serving cell is greater than S_{nonintrasearch}, firstly it is judged whether the user interface is set with the signal optimization; if yes and the duration Tduration2, that the voice or data service performance declines in the non-IDLE state before IDLE, is greater than a weak signal timed out optimal time Tuser (recommended as 20 s˜60 s), specified by the user, then the current Ss value is stored in the variant Ss1, and the cell measurement is started.

If the above two conditions are not satisfied at the same time, then the UE resides in the current serving cell, and the measurement is not performed.

[1050, 1060 and 1070]

For frequency points with the same priority, the R criterion of the intra-frequency cell reselection is adopted.

The R criterion refers to as that the serving cell Rs and the target cell Rt respectively satisfy:

Rs=Qmeas,s+QHyst

Rt=Qmeas,t−Qoffset

Herein, Qmeas is a RSRP value of the measurement cell, and Qoffset defines an offset of the target cell. For the inter-frequency cells with the same priorities, the Qoffset includes two parts, an offset based on the cell and an offset based on the frequency.

If the target cell satisfies the S criterion in the Treselection time (the Treselection of same frequency and different frequency may be different, therefore, the T_{reselectionRAT} is used to represent in FIG. 8), and Rt lasts more than Rs, then the UE will reselect the target cell.

[1100 to 1150]

If the neighboring cell list given in the system message broadcasted by the serving cell is searched completely, while a suitable cell still cannot be found, then it is required to scan all neighboring cells, including the intra-frequency and inter-frequency cells, to generate a list Ca of all neighboring cells actively searched by the mobile phone side.

All cells belonging to the neighboring cell list Cn (obtained from the system message) in the neighboring cell list Ca are deleted, because these cells have been scanned.

Those cells which do not belong to the Cn but belong to the Ca are measured, and the current intra-frequency cell list Ca is ranked as per the Rank values from large to small.

[1160 to 1180]

If the target cell Ct in the intra-frequency cell list Ca satisfies the S criterion in the T_{reselection} time (the T_{reselection} of same frequency and different frequency may be different, therefore, T_{reselectionRAT} is used to represent in FIG. 8), and Rt lasts more than Rs, then the UE will actively reselect the target cell Ct with the strongest and best signal.

On the contrary, if no cell in the cell list Ca satisfies the condition in [1160], then it indicates that all current neighboring cells do not satisfy the reselection condition, and the UE can only continue to reside in the original serving cell Cs.

[1190 to 1220]

The UE actively reselects the target cell Ct which does not belong to neighboring cell list Cn given in the system broadcast message, which is only a non standard process of the mobile phone side; therefore, after the signal strength and quality of the original serving cell is recovered, it still should give priority to reselecting the cell Cs in the neighboring cell list Cn.

While now, if the signal qualities of both Ct and Cs are getting worse, the reselection must be performed in the Cn.

Although the above text describes the present document in detail, the present document is not limited here. Those skilled in the art can make various modifications according to the principles of the present document. Therefore, all the modifications made according to the principles of the present document should be understood to be embodied in the protection scope of the present document.

### INDUSTRIAL APPLICABILITY

Through the above embodiments and preferred implementation modes, the following effects can be achieved: a terminal can actively search for an optimum cell existing around and reside under the scenario of weak signals, which is beneficial to improve wireless performance and user experience.

What is claimed is:

1. A method for cell reselection for a terminal, comprising the following steps:
when performing cell reselection according to signal quality or service performance of a serving cell, a terminal acquiring a first neighboring cell list from a system side;
selecting a neighboring cell satisfying a cell reselection condition from the first neighboring cell list; and
if none of neighboring cells in the first neighboring cell list satisfies the cell reselection condition, then the terminal performing active search to obtain other neighboring cell satisfying the cell reselection condition, and residing in the other neighboring cell satisfying the cell reselection condition.

2. The method according to claim 1, wherein, the terminal performs the cell reselection when the service performance of the terminal declines and a duration that the service performance declines is greater than a preset declination time.

3. The method according to claim 1, wherein, the step of the terminal performing active search to obtain other neighboring cell satisfying the cell reselection condition, and residing in the cell comprises:
through the active search, the terminal acquiring the other neighboring cells, which are supported by the terminal, other than the neighboring cells in the first neighboring cell list, to generate a second neighboring cell list;
determining priorities of various neighboring cells by means of respectively performing cell measurements on the various neighboring cells in the second neighboring cell list;
selecting a neighboring cell with a highest priority, and judging whether the neighboring cell with the highest priority satisfies the cell reselection condition; and
if the neighboring cell with the highest priority satisfies the cell reselection condition, then residing in the neighboring cell with the highest priority.

4. The method according to claim 3, wherein, the step of generating a second neighboring cell list comprises:
the terminal actively searching for frequency points and network modes supported by the terminal to obtain all neighboring cells of the service cell; and
deleting the neighboring cells in the first neighboring cell list from all obtained neighboring cells, to obtain the second neighboring cell list generated by remaining neighboring cells.

5. The method according to claim 3, wherein, the step of determining priorities of various neighboring cells by means of respectively performing cell measurements on the various neighboring cells in the second neighboring cell list comprises:
obtaining signal strengths and qualities of the various neighboring cells by means of respectively performing cell measurements on the various neighboring cells in the second neighboring cell list; and
by using the signal strengths and qualities of the various neighboring cells, obtaining the priorities of the various neighboring cells respectively, and ranking the priorities in a sequence from high to low.

6. The method according to claim 3, wherein, the step of judging whether the neighboring cell with the highest priority satisfies the cell reselection condition comprises:
judging whether the neighboring cell with the highest priority satisfies the cell reselection condition when the neighboring cell with the highest priority satisfies an S criterion that the signal quality is greater than 0 and a duration where the priority of the neighboring cell with the highest priority is higher than a priority of the serving cell, is greater than a preset reselection time.

7. The method according to claim 1, wherein, after the step of residing in the other neighboring cell satisfying the cell reselection condition, the method further comprising:
the terminal monitoring the signal quality of an original serving cell; and
the terminal residing in the original serving cell again if a duration where the signal quality of the original serving cell is better than that of a current resident cell, is greater than the preset reselection time.

8. An apparatus for cell reselection for a terminal, comprising:
an acquiring module, configured to, when a terminal performs cell reselection according to signal quality or service performance of a serving cell, acquire a first neighboring cell list from a system side;
a selection module, configured to select a neighboring cell satisfying a cell reselection condition from the first neighboring cell list; and
a reselection module, configured to, if none of neighboring cells in the first neighboring cell list satisfies the cell reselection condition, then perform active search by the terminal to obtain other neighboring cell satisfying the cell reselection condition, and reside in the other neighboring cell satisfying the cell reselection condition.

9. The apparatus according to claim 8, wherein, the terminal performs the cell reselection when the service performance of the terminal declines and a duration that the service performance declines is greater than a preset declination time.

10. The apparatus according claim 8, wherein, the reselection module is further configured to reside in an original serving cell again if monitoring a duration where the signal quality of the original serving cell is better than that of the current resident cell, is greater than a preset reselection time.

11. The method according to claim 2, wherein, after the step of residing in the other neighboring cell satisfying the cell reselection condition, the method further comprising:
the terminal monitoring the signal quality of an original serving cell; and
the terminal residing in the original serving cell again if a duration where the signal quality of the original serving cell is better than that of a current resident cell, is greater than the preset reselection time.

12. The method according to claim 3, wherein, after the step of residing in the other neighboring cell satisfying the cell reselection condition, the method further comprising:
the terminal monitoring the signal quality of an original serving cell; and
the terminal residing in the original serving cell again if a duration where the signal quality of the original serving cell is better than that of a current resident cell, is greater than the preset reselection time.

13. The method according to claim 4, wherein, after the step of residing in the other neighboring cell satisfying the cell reselection condition, the method further comprising:
the terminal monitoring the signal quality of an original serving cell; and
the terminal residing in the original serving cell again if a duration where the signal quality of the original serving cell is better than that of a current resident cell, is greater than the preset reselection time.

14. The method according to claim 5, wherein, after the step of residing in the other neighboring cell satisfying the cell reselection condition, the method further comprising:
the terminal monitoring the signal quality of an original serving cell; and
the terminal residing in the original serving cell again if a duration where the signal quality of the original serving cell is better than that of a current resident cell, is greater than the preset reselection time.

15. The method according to claim 6, wherein, after the step of residing in the other neighboring cell satisfying the cell reselection condition, the method further comprising:
the terminal monitoring the signal quality of an original serving cell; and
the terminal residing in the original serving cell again if a duration where the signal quality of the original serving cell is better than that of a current resident cell, is greater than the preset reselection time.

16. The apparatus according claim 9, wherein, the reselection module is further configured to reside in an original serving cell again if monitoring a duration where the signal quality of the original serving cell is better than that of the current resident cell, is greater than a preset reselection time.
